(19) United States
(12) Patent Application Publication
(10) Pub. No.: US 2006/0186240 A1
(43) Pub. Date: Aug. 24, 2006

(54) Disintegrator with improved contour

(75) Inventors: Edmund Schuller, Ingolstadt (DE); Joseph Schermer, Bergheim-Unterstall (DE)

Correspondence Address: DORITY & MANNING, P.A., POST OFFICE BOX 1449, GREENVILLE, SC, 29602-1449, US

(73) Assignee: RIETER INGOLSTADT SPINNEREIMASCHINENBAU AG

(21) Appl. No.: 11/271,512

(22) Filed: Nov. 10, 2005

(30) Foreign Application Priority Data
Nov. 11, 2004 (DE) 10 2004 054 653.3

(51) Int. Cl. B02C 13/28

(52) U.S. Cl. 241/294

(57) ABSTRACT

The invention concerns a disintegrator apparatus for textile machines, especially for spinning machines, i.e., openend spinning machines, with a disintegrator, on the outer circumference of said disintegrator a plurality of teeth (2) are placed. The invented disintegrator apparatus characterizes itself thereby, in that the teeth (2) are placed at a tooth spacing (L_{Z}) of, at the greatest, 20 mm, preferably less than 12 mm and said teeth at least consist of two sections, whereby a first section located at a tooth apex (5) exhibits a positive or at least a vertical forward rake (W_{B}) and a second section is an incline, falling in the direction of movement (3) of the operative equipment, and that the separation distance between the apex of the tooth (5) and a tangential joining point of the vertical tangent (10) creates a transition zone between the said first and the second sections and forms a technologically effective tooth height (Hₜ), whereby the ratio of the said technologically effective tooth height to the spacing between teeth is at the most, unity, i.e., 1.

The present invention concerns a disintegrator for textile machines, especially for spinning machines, such as, for example, open-end or air-nozzle spinning machines, wherein a plurality of teeth is placed on the outer circumference of a disintegrating roll.

In the case of modern textile machines, such as, for example, spinning machines, the production of a thread from a fibers requires that these fibers be released from the compaction of the feed material to form individual, free fibers. This is carried out prior to the subjection of the fibers to the next operation, which could possibly be a spinning procedure to produce a fiber band from which thread can be spun. At this point, partially different requirements are brought to bear on disintegration apparatuses. The reason for this can be attributed to entirely different kinds of fibers, which are to be worked, each of which additionally, calls for entirely different work-up conditions. For example, one can mention here the difference between cotton fibers and chemically produced fibers. Both types of fibers possess very differing fiber characteristics, which are necessary to cope with in a disintegrator apparatus. Moreover, cotton fibers are frequently contaminated with foreign materials and carry substances such as such as shells or sand, which are to be treated in the process without causing disturbances.

In former years, on this account, a multitude of tooth geometries for disintegrator apparatuses were developed, each of which, for example, sought to achieve a universality of application for many materials. That is to say, it was desirable that each disintegrator could work with the greatest number of fiber types. Other tooth geometries were specialized to treat individual types of fibers and were consequently optimized for one fiber type of a narrow range of properties. The result of this was, that these specialty disintegrators, became limited in their usage and for example, were applied either only for natural fibers such as cotton or were exclusively intended for synthetic fibers of the like of viscose or polyester fibers.

Additionally, DE 199 21 965 A1 discloses a fine-tooth equipped disintegrator roll for an open end spinning machine, which is furnished with teeth, the height of which clearly exceeds the pitch thereof and which teeth exhibit a positive, forward angle (hereinafter “forward rake”) of inclination from the vertical. Included in this careful arrangement of the teeth, provision has been made, that the allotment of teeth per unit length is at least three time the height of the said teeth and the forward rake is at least 10°. Such toothing, wherein the tooth height could lie under 2 mm, is determined to be a specialty reserved for the working of synthetic fiber materials. The very close spacing of the teeth has the purpose of assuring, that the relatively stiff fibers of synthetic material at the entrance of a machine intake fitting, properly disengage from the said teeth. The fine teeth, placed close to one another, prevent the fibers from penetrating too deeply into the toothing. This has the effect, that these said fibers easily release themselves, a characteristic which is highly desirable in an approach to a spinning machine feed fitting.

The technological characteristics of disintegration apparatuses do not, however, lie only in the size of the teeth in service, but the very geometry thereof has a decisive influence. As an example, under this classification would be included the very important forward rake of individual teeth and the provided, relative speed between the tooth and the fibers. Starting considerations from this state of the technology, experience has demonstrated, that in particular application cases, difficulties can always arise due to the geometry of the tooth. The reason for this is that, definite tooth-geometries have a good result in separating the incoming fibers, but with which geometry, said teeth then yield individual fibers in an insufficient amount. Conversely, other tooth geometries exhibit a good yield of the disintegrated fibers, but at the same time leave something to be desired as to the breaking up of the incoming fiber band.

Thus, the purpose of the invention is, to create a tooth geometry, which provides such assistance, that, simultaneously, first a good possibility for disintegration of fiber material exists, and second a satisfactory yield of free fibers can be obtained after the disintegration procedure ends.

For achieving the above stated purpose, the invented disintegration apparatus is characterized, in that the teeth are apportioned with a separation distance between them of, at the most, 20 mm, preferably of less than 12 mm, and each tooth at least consists of two sections, whereby a first section, located at the a tooth apex possesses a positive or at least a perpendicular forward rake and the second section has, in the direction of movement of the equipment, a declining slant. Further, the separating distance between the apices of the teeth and an joining point of a vertical tangent at the transition zone between the said first and the second sections form a technologically effective tooth height, whereby the ratio between the technologically effective tooth height to the inter-tooth spacing runs not greater than unit (1). In the case of the arrangements intended for the synthetic fibers, these have, for example, technologically effective tooth heights of about 1 mm and a tooth separation of about 4 mm, which has shown itself as being particularly effective. The ratio, computed as above for this arrangement, runs 0.25. The technologically effective tooth heights, which are particularly advantageously put to use, lie predominately in a range between 0.3 and 1.8 mm, preferably about 1 mm.

The invention takes advantage of the fact, that the subdivision of a tooth into two or more sections, enables the accomplishment of the said purpose of the invention as mentioned in the introductory passages. Thus, the first section of the tooth, which section extends itself from apex of the tooth to the base thereof, forms that stretch of distance, to which can be attributed the especially favorable disintegration possibilities of the invented disintegration apparatus. That side of the tooth, which lies forward in the direction of movement, which side might also be called the side of confrontation, stands vertically or is slightly tilted in the forward direction. The more the forward rake is inclined forward, i.e., in the direction of motion, just that much will the forward rake increase in measurement, and just that much more the capability of disintegration of the so disposed teeth improves, for the reason, that under these circumstances, the fibers have a better chance of seizing upon the tooth structure. Contrary to conventional tooth-geometries, wherein the fibers, likewise, do adhere well, the invention also achieves the advantage, that the fibers can easily disengage themselves. Thus, the situation has been, that up to this time, apparatuses were known, wherein the fibers had the capability of dispersing themselves especially well, but this was linked to the disadvantage of the undesirable property of the fiber to subsequently agglomerate within the disintegrator. In the present case, the invention creates an aid by shaping the second section of the tooth in such a manner, that an area exists from half the tooth height down to the base thereof. This second section is thus made as an inclined slide, which declines in the direction of motion of the disintegration apparatus. This said incline, then prevents the fibers from imperviously collecting themselves at the base of the tooth, since they can now inventively slide along for release. In this manner, the disseminated fibers remain largely collected in the upper zone of the tooth and release themselves at the desired position, this being, for example, at an opening to a fiber feed channel. The disintegrating apparatus, in accord with the invention, thus combines the advantage of an especially favorable tooth geometry with the advantage of a an especially favorable releasing tooth geometry.

In the case of an especially favored embodiment of the invention, provision is made, that between the vertical tangents and the second section, an angle of 3° to 60°, preferably 30° to 50° is closed. Inclined surfaces in angular disposition have shown themselves as being especially effective in these areas. It is particularly advantageous if the teeth, in keeping with the invention, are integral with a carrier wire, which in turn is affixed on a disintegrator roll. These so toothed wires can be fabricated from long strands and at that time, be custom adapted.

A particularly favorable dimensioning is established, if the base height of the toothed wire is less than 2.5 mm. The toothed wire consists, generally, of a reasonably long wire base. This means that this wire, at the latest, upon the equipping of the disintegrator roll body, can be bent into a helical coil which is internally commensurate with the outer circumference of the roll. For instance, the said bending can be carried out during mounting or even in a preliminary step of manufacture, such as prior to a hardening process. Experience has shown that toothed wiring with a base height of less than 2.5 mm is still easily shaped, without, for example, the occurrence of fissures or breaks, which would cause extreme damage to the finished toothed wire. Especially, toothed wires with base heights in the range of 1.5 to 2.4 mm have functioned in many applications without operational problems and have given evidence of satisfactory structural strength.

For the determination of an especially functional tooth contour, advantage has been shown of satisfactory performance, when, in the case of the disintegrator apparatus, the ratio of technologically effective tooth-height to the base height lies between 0.2 and 1.5, or better, between 0.7 and 1. If one employs, for example, a technologically effective tooth-height of 1 mm and a base height of 1.8 mm, then the result provides a ratio of 0.55.

Moreover, the tooth contour has shown itself as advantageous for the capability of disintegration, when the angle of forward rake lies within a range of 0° to 10°.

In the following, the disintegrating rolls, proposed by the invention, the toothed wire and the equipping therewith, characterize themselves throughout, in that the therewith associated tooth-contour is in accord with the previously described embodiment forms. In accord therewith, for these components, the same advantages may be accorded thereto, as for the foregoing, described disintegrating apparatus.

Further advantages and features of the invention are evident in the following description of an embodiment example. The drawing shows:

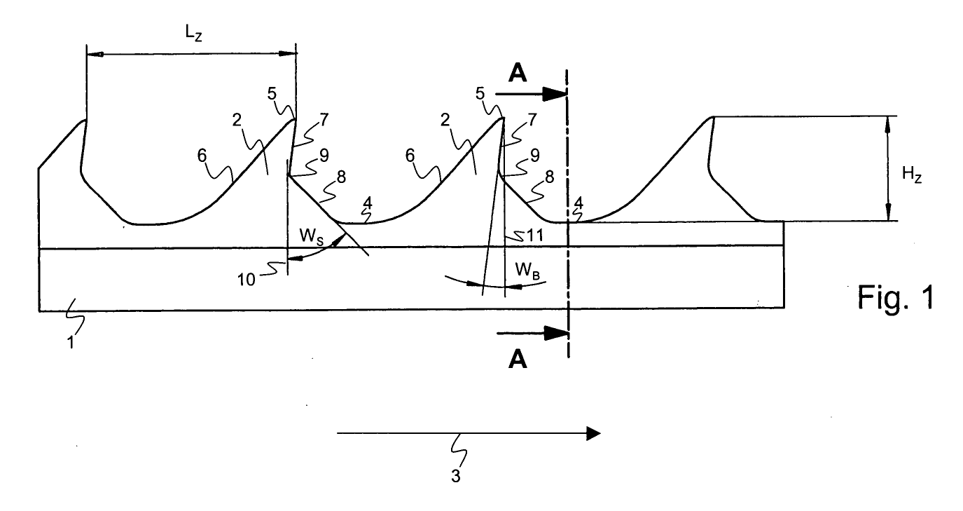

FIG. 1 a profile view of a section of an invented toothed wire,

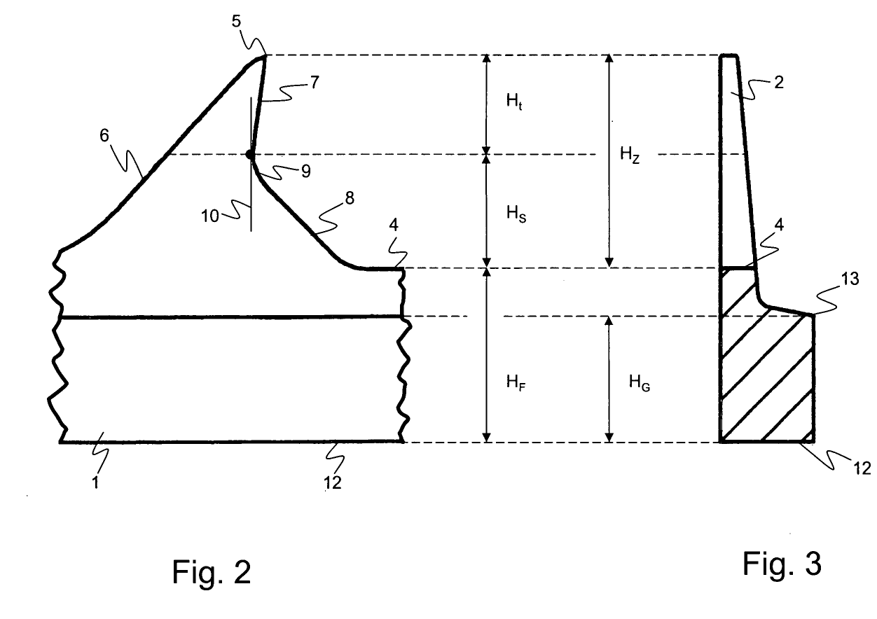

FIG. 2 an enlarged presentation of a single tooth of the invented toothed wire of FIG. 1 and

FIG. 3 a sectional view along the line A-A through the invented toothed wire of FIG. 1.

In FIG. 1 is presented a profile of a section of an invented toothed wire. On the upper side of the toothed wire 1 are arranged four teeth 2. The teeth 2 are respectively pitched at a separating distance from one another by the distance L_{Z}. The provided direction of motion of the toothed wire 1 is indicated to be in the direction of the arrow 3, i.e., to the right of the drawing. The teeth 2 show a tooth height Hz. which extends itself from the top of the base 4 up to the apex 5 of the tooth. The back side of the tooth 2 is formed by a tooth-back 6, which inclines at an angle of 45°. The forward side of the tooth 2 is subdivided into two sections, whereby the first section is formed by the forward rake inclination and the second section consists of the incline 8. All sections of the tooth contour, that is to say, the tooth back 6, the forward rake 7, the incline 8 and the base of the tooth 4 fare tangentially into one another and are bound together individually by radii of different lengths. On a rounding 9, between the forward rake area 7 and the incline 8, is to be seen (FIG. 1) a vertical tangent 10, the touching point thereof plus the rounding 9 form the underside of a technologically effective tooth height. The upper border of the technologically effective tooth height lies on the apex 5. Between the vertical tangent 10 and the incline 8 is opened an angle W_{S}, which, in the present case is shown as ca. 45°. The forward facing, confronting surface 7 is, on its own, has a forward rake angle W_{B} relative to a vertical 11. The forward rake angle W_{B} in the present FIG. 1, is chosen as positive, so that the tooth apex 5 projects into the direction of motion. What is shown in the drawn embodiment, is actually a positive forward rake of some 7°.

In FIG. 2 is demonstrated a tooth 2 of the toothed wire 1 from FIG. 1, this time enlarged 100%. The enlarged version demonstrates with particular clarity the positioning of the technologically effective tooth height Hₜ. This dimension extends itself from the apex 5 to that tangent point where vertical line 10 fares into the rounding 9. The incline 8 extends itself from the said tangential, joining point downward to the foot 4 of the tooth. The base height H_{F} runs from the foot 4 of the tooth again downwards to a bottom edge 12 of the toothed wire 1. The height H_{G} extends itself from a side edge 13 down to the bottom edge 12 and is also the height of intervening valleys between the eventually roll wound tooth rows. The base height H_{F} of the toothed wire, designed in accord with the invention, should not exceed 2.5 mm. In the case of advantageous embodiment examples, the said base height H_{F} is selected within a range of 1.5 to 2.2 mm. The height H_{G} is favorably set within the limits 1.0 and 1.7 mm. In almost all instances, it is also sufficient to choose a technologically effective tooth height Hₜ which would lie in the range of 0.5 to 1.5 mm. In exceptional cases, the technologically effective tooth height Hₜ, however, can be selected above or below these given limits.

Finally, FIG. 3 shows a sectional cut through the invented toothed wire in accord with the sectional line A-A of FIG. 1. It is recognizable in this FIG. 3, that the left side of the toothed wire is a vertical plane, while, conversely, the right side of the tooth is angular in formation, so that the tooth 2 tapers upward. This is a possible technical embodiment shape, as this is frequently chosen in the stamping procedure of wire manufacture for toothed wires. Along with this shape, for example, are also other symmetric shape forms of the tooth longitudinal profile which can be used within the framework of the invention. Also, the underside of the of the said toothing valley, which rises initially from an angle from the edge 13 in the direction of the tooth 2, can optionally also be formed in a horizontal manner, whereby the effect of the invention is not brought into question.

Moreover, the present invention is not limited to the described embodiment example. There are many more alterations of the invention are possible within the limits of the patent claims. Thus, it is possible that within the disclosed value areas, a multitude of different contours can be conceived, which, all together exhibit the advantages of the invention and so fall within the scope of the invention. Beyond this, the invention is uniformly advantageous on both rings of invented toothing as well as on the described toothed wires.

Claimed is:

1. A disintegration apparatus for textile machines, especially for spinning machines, namely spinning machines of the open end type, having a disintegration apparatus, on the outer circumference of which a multiplicity of teeth (2) is placed, therein characterized
in that the teeth (2), are installed with a tooth spacing (L_{Z}) of, at the greatest, 20 mm, preferably less than 12 mm and each of which teeth comprise at least two sections, whereby a first section located at a tooth apex (5) possesses a positive or at least a perpendicular forward rake (W_{B}) and a second section is an incline (8) falling away in the direction of travel (3) of the technical furnishings and
in that the separating distance between apex point 5 and a tangential coalescing point of a vertical tangent (10) on the transition zone between the first and the second sections forms a technological effective tooth height (Hₜ), wherein the ratio of such a technologically effective tooth height to tooth spacing runs at the greatest 1.

2. A disintegration apparatus in accord with the foregoing claim, therein characterized, in that between the vertical tangent (10) and the second section, an angle lies, measuring 3° to 60°, preferably 30°-50°.

3. A disintegration apparatus in accord with one of the foregoing claims, therein characterized, in that the teeth (2) are found on a carrier wire, which is subsequently fastened onto a disintegrator roll body.

4. A disintegration apparatus in accord with one of the foregoing claims, therein characterized, in that the dimension of a tooth base (H_{F}) of the toothed wire is less than 2.5 mm.

5. A disintegration apparatus in accord with one of the foregoing claims, therein characterized, in that the ratio of technologically effective tooth height (Hₜ) to the tooth base (H_{F}) is between 0.2 and 1.5, preferably between 0.7 and 1.

6. A disintegration apparatus in accord with one of the foregoing claims, therein characterized, in that the forward rake (W_{B}) lies in a range of 0°-10°.

7. A disintegrator roll for textile machines, especially for spinning machines having a toothed wire or a toothed ring, therein characterized, in that the therewith accompanying tooth contour is constructed in accord with one of the foregoing claims.

8. A toothed wire, or a toothed ring for textile machines, especially for spinning machines, therein characterized in that the therewith accompanying tooth contour is in accord with one of the foregoing claims.
